(19) United States
(12) Patent Application Publication
(10) Pub. No.: US 2016/0318334 A1
(43) Pub. Date: Nov. 3, 2016

(54) LIGHTWEIGHT, HIGH STRENGTH WHEEL RIM FOR BICYCLE

(71) Applicant: ALEX GLOBAL TECHNOLOGY, INC., Tainan City (TW)

(72) Inventor: WEI-CHIN CHEN, TAINAN CITY (TW)

(21) Appl. No.: 14/701,850

(22) Filed: May 1, 2015

(51) Int. Cl. B60B 1/00; B60B 21/06; B60B 1/04

(52) U.S. Cl. CPC B60B 1/003; B60B 1/041; B60B 1/048; B60B 21/062

(57) ABSTRACT

A lightweight, high strength wheel rim for bicycle is disclosed. A support member is retained in each spoke hole in the inner periphery of a wheel frame via a sleeve and reclined on the inner periphery of the wheel frame by an arc-shaped contact section. A connector is inserted into the sleeve and abutted to the support member by an abutting part. A spoke is screwed into the connector, and a cladding is covered the wheel frame and the support member and extended to the outer periphery of the wheel frame. Because the spoke is screwed into the connector, the tension in the spoke applied on the connector is dispersed evenly, resulting that the connector does not directly presses on the periphery of the spoke hole, thereby avoiding it from deformation, achieving the demand of lightweight and preventing the appearance from destroys, further increasing the effect of whole wheel rim.

### BACKGROUND OF THE INVENTION

1. Field of the Invention

The present invention relates a lightweight, high strength wheel rim for bicycle. More particularly, the structure design of a wheel rim not only avoids the periphery of the spoke hole on the wheel frame from transformation, but also achieves the demand of lightweight and prevents the appearance from destroy, thereby increasing the effect of whole wheel rim.

2. Description of Related Art

Bicycle is a very convenient transportation. It is pedal-driven by user's feet to move, not only has the fitness effect, but also a best tool for doing exercise. Moreover, it does not need additional fuel, so it is energy-saving and has the effect of environmental protection. Furthermore, the speed of bicycle is slower, so it is safer in use. For the students who are too young to ride a motorcycle and drive a car, the bicycle is one of the essential transportations, resulting that the demand of bicycle is more and more increased in recently years. Bicycle is regarded as one of the most popular transportation and fitness equipment. With the popularization of the bicycle, various kinds of bicycle are researched and developed, such as road bike for riding on a general road, mountain bike for riding on a rugged road, folding bicycle for convenient to fold and store away, and mini velo which is small volume for convenient to store away.

A common bicycle is composed of a wheel hub, spokes, a wheel frame, and a pneumatic tire. The wheel hub is on the central of the wheel for assembling with the bike frame. One end of the spokes is connected to the periphery of the wheel hub, and the other end of the spokes is connected to the wheel frame. Furthermore, the pneumatic tire is fitted around the wheel frame. Therefore, the wheel rotates upon the wheel hub as an axle center.

As far as the connection between the spokes and the wheel frame is concerned, please refer to FIG. 4, which is a sectional view of a wheel rim according to the prior art. The traditional wheel frame 6 is formed with a reinforcement part 61 in the inner periphery thereof, and the reinforcement part 61 has thicker body. Several spoke holes 62 are arranged on the reinforcement part 61, and a connector 63 is retained in the each of spoke holes 62. An abutting part 631 is protruded from the outer periphery of the connector 63 for abutting the inner side of the spoke hole 62 of the wheel frame 6, avoiding the connector 63 retained in the spoke hole 62 from dropping. The spoke 64 is connected with the connector 63 to make the connection between the spokes 64 and the wheel frame 6.

However, when the foregoing structure is actually used, it is found that because the abutting part protruded from the outer periphery of the connector is abutted the inner side of the spoke hole of the wheel frame, the abutted site on the inner side of the spoke hole is pressed by the connector due to the pull of the spoke after the spoke and the connector are assembled. Accordingly, the inner periphery of the wheel frame has the reinforcement part which body is thicker for increasing the support for the connector, avoiding the wheel frame from transformation. Nevertheless, it causes that the weight of the wheel frame is heavier, so it is not fit the lightweight demand of the modern bicycle, and correspondingly, more material is consumed, resulting in the increase of the manufacture cost.

In addition, some manufacturers set up several spoke holes in the inner periphery of the wheel frame, and weld the connector into the spoke hole for assembling the connector with the spoke. However, the weld of the spoke hole and the connector not only destroys the strength of the wheel frame during welding, resulting in the doubt about safety, but also affects the appearance of the whole wheel frame. Therefore, the whole structure design must be improved.

### SUMMARY OF THE INVENTION

Therefore, the object of the present invention is to provide a lightweight, high strength wheel rim for bicycle, which comprising a support member retained in a spoke hole of a wheel frame for supporting an abutting part of a connector. Because the spoke is screwed into the connector, the tension in the spoke applied on the connector is dispersed evenly, resulting that the connector do not directly presses on the periphery of the spoke hole, thereby avoiding it from deformation, achieving the demand of lightweight and preventing the appearance from destroys, further increasing the effect of whole wheel rim.

For the above object, a lightweight, high strength wheel rim for bicycle is disclosed, comprising a wheel frame, a support member, a connector, a spoke, and a cladding. The wheel frame is formed with several spoke holes arranged in the inner periphery thereof. The support member is retained in one of the spoke holes of the wheel frame. The support member has a sleeve corresponding to one of the spoke holes of the wheel frame for inserting the support member into the spoke hole and an arc-shaped contact section corresponding to the inner periphery of the wheel frame for reclining the support member on the inner periphery of the wheel frame. The connector is inserted into the sleeve of the support member and has an abutting part to abut to the support member. The spoke is screwed into the connector. The cladding is covered the inner periphery of the wheel frame and the support member, further covered the outer periphery of the wheel frame, wherein the cladding is made of carbon fiber.

### BRIEF DESCRIPTION OF THE DRAWINGS

FIG. 1 is an exploded view of a lightweight, high strength wheel rim for bicycle according to the embodiment of the present invention;

FIG. 2 is a front and sectional view of a lightweight, high strength wheel rim for bicycle according to the embodiment of the present invention;

FIG. 3 is a side and sectional view of a lightweight, high strength wheel rim for bicycle according to the embodiment of the present invention; and

FIG. 4 is a sectional view of a wheel rim according to the prior art.

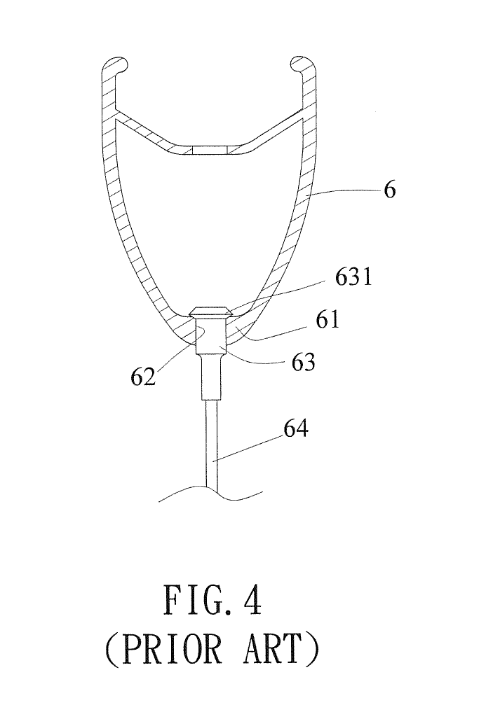

### DETAILED DESCRIPTION OF THE PREFERRED EMBODIMENT

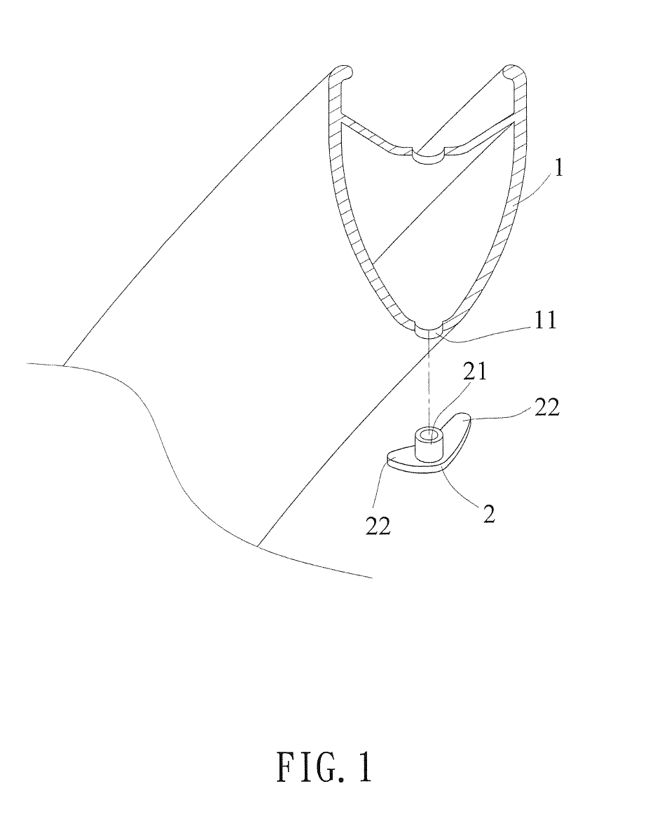

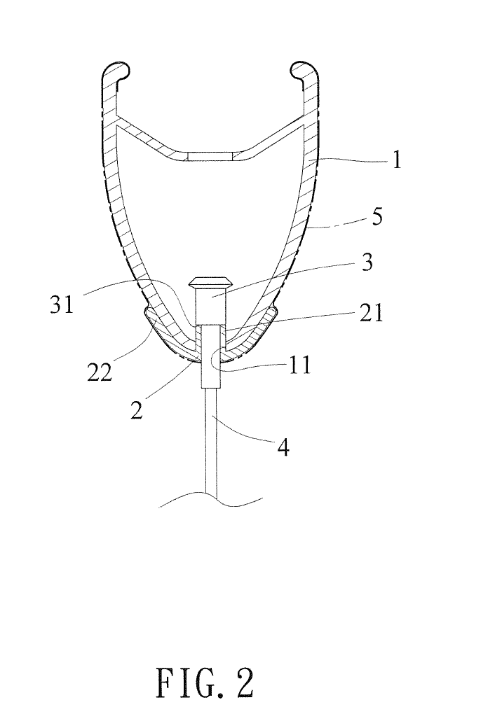

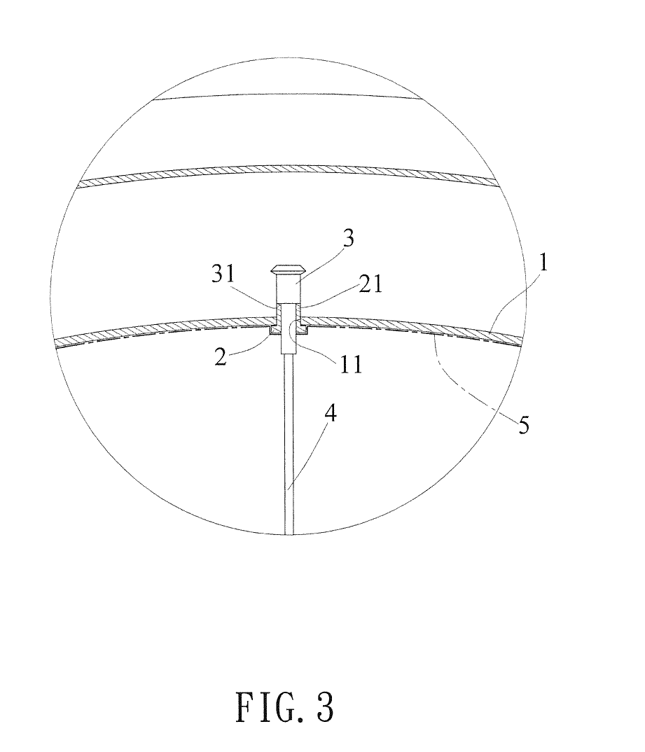

Please refer to FIG. 1 to FIG. 3, which are an exploded view, a front and sectional view, and a side and sectional view of a lightweight, high strength wheel rim for bicycle according to the embodiment of the present invention, respectively. The lightweight, high strength wheel rim for bicycle of the present invention comprises a wheel frame 1, a support member 2, a connector 3, a spoke 4, and a cladding 5.

The wheel frame 1 is formed with several spoke holes 11 arranged in the inner periphery thereof.

The support member 2 is retained in one of the spoke holes 11 of the wheel frame 1. The support member 2 has a sleeve 21 corresponding to one of the spoke holes 11 of the wheel frame 1 for inserting the support member 2 into the spoke hole 11 of the wheel frame 1 and an arc-shaped contact section 22 corresponding to the inner periphery of the wheel frame 1 for reclining the support member 2 on the inner periphery of the wheel frame 1.

The connector 3 is inserted into the sleeve 21 of the support member 2 and has an abutting part 31 to abut to the support member 2 to avoid the connector 3 from dropping from the sleeve 21 of the connector 2.

The spoke 4 is screwed into the connector 3.

The cladding 5 is covered the inner periphery of the wheel frame 1 and the support member 2, further covered the outer periphery of the wheel frame 1. The cladding 5 is made of carbon fiber.

Accordingly, when the foregoing components of the present invention are assembled together, each of spoke holes 11 arranged in the inner periphery of the wheel frame 1 is set with one support member 2. In detail, the sleeve 21 of the support member 2 is inserted into the spoke hole 11 of the wheel frame 1, and the arc-shaped contact section 22 is reclined the support member 2 on the inner periphery of the wheel frame 1. The connector 3 is inserted into the sleeve 21 of the support member 2 and the abutting part 31 of the connector 3 is abutted on the support member 2. The spoke 4 is screwed into the connector 3. The cladding 5 is covered the inner periphery of the wheel frame 1 and the support member 2, further covered the outer periphery of the wheel frame 1.

Therefore, when the spoke 4 is screwed into the connector 3, the tension in the spoke 4 applied on the connector 3 is dispersed evenly to the support member 2. Furthermore, the support member 2 is reclined on the inner periphery of the wheel frame 1 via the arc-shaped contact section 22, meanwhile, the cladding 5 is covered the support member 2 along with the wheel frame 1, so the connector 3 does not directly presses on the periphery of the spoke hole 11, avoiding the periphery of the spoke hole 11 of the wheel frame 1 from deformation.

According to the above description and embodiments, in the lightweight, high strength wheel rim for bicycle of the present invention, it has the support member in the spoke hole of the wheel frame for supporting the abutting part of the connector, resulting that the tension in the spoke applied on the connector is dispersed evenly after the spoke is screwed into the connector, so that the connector does not directly presses on the periphery of the spoke hole, thereby avoiding it from deformation, achieving the demand of lightweight and preventing the appearance from destroys. Furthermore, the effect of whole wheel rim is increased.

What is claimed is:

1. A lightweight, high strength wheel rim for bicycle, comprising:
a wheel frame, being formed with a plurality of spoke holes arranged in the inner periphery thereof;
a support member, set in one of the spoke holes of the wheel frame, the support member having a sleeve corresponding to one of the spoke holes of the wheel frame for retaining the support member in the spoke hole and an arc-shaped contact section corresponding to the inner periphery of the wheel frame for reclining the support member on the inner periphery of the wheel frame;
a connector, inserted into the sleeve of the support member and having an abutting part to abut on the support member;
a spoke, screwed into the connector; and
a cladding, covered the inner periphery of the wheel frame and the support member, further covered the outer periphery of the wheel frame, wherein the cladding is made of carbon fiber.
